(19) United States
(12) Patent Application Publication
(10) Pub. No.: US 2005/0207486 A1
(43) Pub. Date: Sep. 22, 2005

(54) Three dimensional acquisition and visualization system for personal electronic devices

(75) Inventors: Chuen-Chien Lee, Pleasanton, CA (US); Alexander Berestov, San Jose, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 10/915,648

(22) Filed: Aug. 9, 2004

Related U.S. Application Data
(60) Provisional application No. 60/554,673, filed on Mar. 18, 2004.

(51) Int. Cl. H04N 7/12

(52) U.S. Cl. 375/240.01; 348/42

(57) ABSTRACT

A three-dimensional (3D) acquisition and visualization system for personal electronic devices comprises two digital cameras which function in a variety of ways. The two digital cameras acquire 3D data which is then displayed on an auto-stereoscopic display. For clarity and ease of use, the two digital cameras also function as eye-tracking devices helping to project the proper image at the correct angle to the user. The two digital cameras also function to aid in autofocusing at the correct depth. Each personal electronic device is also able to store, transmit and display the acquired 3D data.

### RELATED APPLICATIONS

This application claims priority under 35 U.S.C. § 119(e) of the U.S. provisional application Ser. No. 60/554,673 filed on Mar. 18, 2004 and entitled “Three-Dimensional Acquisition and Visualization System for Personal Electronic Devices.” The provisional application Ser. No. 60/554,673 filed on Mar. 18, 2004 and entitled “Three-Dimensional Acquisition and Visualization System for Personal Electronic Devices” is also hereby incorporated by reference.

### FIELD OF THE INVENTION

The present invention relates to the field of three dimensional (3D) imaging. More specifically, the present invention relates to a personal electronic device for 3D acquisition and visualization.

### BACKGROUND OF THE INVENTION

Three dimensional technology has been developing for over a century, yet has never been able to establish itself in the mainstream generally due to complexity and cost for the average user. The emergence of Liquid Crystal Display (LCD) and Plasma screens which are better suited to rendering 3D images than traditional Cathode Ray Tube (CRT) monitors and televisions in both consumer electronics and the computer world has spurred interest in the technology. 3D systems have progressed from being technical curiosities and are now becoming practical acquisition and display systems for entertainment, commercial and scientific applications. With the boost in interest, many hardware and software companies are collaborating on 3D products.

Recently, NTT DoCoMo unveiled the Sharp mova SH251iS handset which is the first to feature a color screen capable of rendering 3D images. A single digital camera allows its user to take two dimensional (2D) images and, then using an editing system, convert them into 3D. The 3D images are sent to other phones with the recipient able to see the 3D images if they own a similarly equipped handset. No special glasses are required to view the 3D images on the auto-stereoscopic system. There are a number of problems with this technology though. In order to see quality 3D images, the user has to be positioned directly in front of the phone and approximately one foot away from its screen. If the user then moves slightly he will lose focus of the image. Furthermore, since only one camera is utilized, it can only take a 2D image and then via the 3D editor, the image is artificially turned into a 3D image. Quality of the image is therefore an issue.

One method of producing a stereoscopic image from a 2D image has been patented in U.S. Pat. No. 6,477,267 to Richards whereby at least one object is identified in the original image; the object or objects are outlined; a depth characteristic is defined for each object; and selected areas of the image are displaced accordingly. As discussed above though, converting a 2D image into a 3D image has a number of problems, most importantly, the quality of the resulting 3D image.

Instead of capturing a 2D image with one camera, U.S. Pat. No. 6,664,531 to Gartner et al., discloses a possible configuration to capture a pair of images using two cameras, which observe the parallax effect of an object. Then the left eye will view one image of this pair of stereoscopic images and the right eye will view the other. The human brain can easily merge this pair of images so that the object is viewed as a 3D image.

Another example of acquiring a 3D image with two cameras is disclosed in U.S. Pat. No. 6,512,892 to Montgomery et al. which includes a 3D camera with at least two moveable parallel detector heads.

As described for the DoCoMo product, a user must stay essentially still while viewing a 3D image otherwise he will lose focus. One reason for such an issue is that the image is a multi-image display. Multi-image displays include different images interleaved into a single display medium. The simplest implementation of multi-image displays includes repeating a sequence of left-right images. The distance between each successive image is 65 mm which is equal to the average distance between the viewer's eyes. However, if the viewer moves left or right more than 32 mm then the viewer will see a reverse 3D image. The reverse 3D image is uncomfortable to view and will cause headaches and pain after a while.

The multi-image display can be improved though by utilizing a number of images, each spaced apart by 65 mm. With a number of images, the viewer can move his head left or right and will still see a correct image. However, there are additional problems with this technique. The number of cameras required increases. For example, to have four views, four cameras are needed. Also, since the sets of numbers are repeating, there will still be a position that results in a reverse 3D image, just fewer of them. The reverse image can be overcome by inserting a null or black field between the repeating sets. The black field will remove the reverse 3D issue, but then there are positions where the image is no longer 3D. Furthermore, the number of black fields required is inversely proportional to the number of cameras utilized such that the more cameras used, the fewer black fields required. Hence, the multi-image display has a number of issues that need to be overcome for the viewer to enjoy his 3D experience.

There are a wide variety of viewing apparatuses presently available for viewing 3D images. One type includes viewing apparatuses which require lenses, prisms, or mirrors held in proximity with the viewer's eyes, which are generally less convenient than alternatives which do not require special eyeware. A second type includes lenticular systems which are relatively difficult and expensive to manufacture for high quality image presentation due to the amount of precision associated with their production, if high-resolution images are desired. Moreover lenticular systems will always present images having a lower resolution than the resolution of which the display device to which the lenticular array is attached to is inherently capable. Furthermore, lenticular systems are not well adapted for viewing systems such as computer displays and television, and are therefore not in wide use.

A third type of 3D image viewing apparatus includes parallax barriers for 3D viewing. The systems are grids consisting of transparent sections interspersed with opaque sections that are placed in various relationships to the image being seen or projected, the image is an interspersed composition of regions taken from the left image (to be eventually seen only by the left eye of the viewer) and regions taken from the right image (to be eventually seen only by the right eye of the viewer), the grid or grids being placed in positions which hide regions of the right image from the left eye and hide regions of the left image from the right eye, while allowing each eye to see sections of the display which are showing regions originating from its appropriate image. In such a system, roughly half of the display contains no image. A fourth type disclosed in U.S. Pat. No. 6,252,707 to Kleinberger et al., includes a system for viewing and projection of full-color flat-screen binocular stereoscopic viewing without the use of eyeglasses. Various combinations of light polarizing layers and layers of light rotating means or color filters are used to display a left and right image to the appropriate left or right eye.

One possible option for solving the problems described regarding the multi-image display is a tracking system. U.S. Pat. No. 6,163,336 to Richards discloses an auto-stereoscopic display system with a tracking system. Richards teaches a tracking system that is aware of the position of the viewer and can instruct the display unit to move the position of the displayed images so that they correspond to the correct position of the viewer.

Another problem is the Passive Auto Focus system used in modern digital cameras which function based on measuring the high frequency content of the picture and changing the focus setting until this measure reaches the maximum. Such a method is slow and fails frequently. U.S. Pat. No. 6,616,347 to Dougherty discloses a number of dual camera systems for autofocusing as prior art, although they all have problems including being too bulky, costly, and heavy. Furthermore, there were difficulties aligning parts of the images from the two cameras. U.S. Pat. No. 6,611,268 to Szeliski et al. discloses utilizing two video cameras where at least one of the cameras is a video camera to estimate the depth map of a scene.

Furthermore, while a number of wireless hand-held digital cameras exist as disclosed in U.S. Pat. No. 6,535,243 to Tullis, such wireless devices are devoid of 3D capabilities. Hence the need to explore such possibilities further.

Projection of 3D images has also been developed in the past, but there is a need for advancement. U.S. Pat. No. 6,252,707 to Kleinberger et al. discloses a 3D projector system that comprises of two projectors which project a 3D image on a screen without the need for special eyewear. The projectors have been a motion picture projector, a television projector, a computer-driven projection device, a slide projector, or some other equipment similar in size, hence the size of these projectors is quite large.

### SUMMARY OF THE INVENTION

A three-dimensional (3D) acquisition and visualization system for personal electronic devices comprises two digital cameras which function in a variety of ways. The two digital cameras acquire 3D data which is then displayed on an auto-stereoscopic display. For clarity and ease of use, the two digital cameras also function as eye-tracking devices helping to project the proper image at the correct angle to the user. The two digital cameras also function to aid in autofocusing at the correct depth. Each personal electronic device is also able to store, transmit and display the acquired 3D data.

In one aspect, a system for acquiring and displaying three-dimensional information comprises an electronic device, a plurality of digital cameras coupled to the electronic device for autofocusing on and acquiring the three-dimensional information and a display coupled to the electronic device for displaying the three-dimensional information. The electronic device is from a group consisting of a PDA, camera phone, laptop computer, digital camera, video camera, and electronic watch. The three-dimensional information includes a set of images. The digital cameras include one or more charged coupled device sensors for acquiring the three-dimensional information. Autofocusing is determined by calculations whereby the calculations are from a group consisting of optical triangulation, range finding, and light pattern warping. The three-dimensional information is processed including compression, formatting, resolution enhancement, and color enhancement. The three-dimensional information is stored in a local memory in a stereo format, wherein the stereo format is one or more of above-below, line-alternate, side-by-side, cyberscope, squashed side-by-side, and JPS stereoscopic JPEG. The plurality of digital cameras track one or more of a viewer's head and eyes while displaying the three-dimensional information. The system further comprises one or more infrared lasers for tracking the one or more of a viewer's head and eyes while displaying the three-dimensional information. However, the system does not require using one or more infrared lasers for tracking the one or more of a viewer's head and eyes while displaying the three-dimensional information. The three-dimensional information is viewed without a viewing aid. Alternatively, the three-dimensional information is viewed with a viewing aid. In another alternative, the display displays two-dimensional information. In yet another alternative, the display is a projection display. The system further comprises a communication interface for communicating with one or more other devices to transmit and receive the three-dimensional information. Specifically, the communication interface communicates wirelessly. The system further comprises a control interface coupled to the electronic device for controlling the electronic device.

In another aspect, a system for acquiring and displaying three-dimensional information comprises an electronic device, a plurality of digital cameras coupled to the electronic device for acquiring the three-dimensional information and a display coupled to the electronic device for displaying the three-dimensional information, wherein the plurality of digital cameras track one or more of a viewer's head and eyes and adjust the three-dimensional information as it is displayed based on a position of the one or more of the viewer's head and eyes. The electronic device is from a group consisting of a PDA, camera phone, laptop computer, digital camera, video camera, and electronic watch. The three-dimensional information includes a set of images.

The digital cameras include one or more charged coupled device sensors for acquiring the three-dimensional information. The plurality of cameras are further utilized for autofocusing. Autofocusing is determined by calculations whereby the calculations are from a group consisting of optical triangulation, range finding, and light pattern warping. The three-dimensional information is processed including compression, formatting, resolution enhancement, and color enhancement. The three-dimensional information is stored in a local memory in a stereo format, wherein the stereo format is one or more of above-below, line-alternate, side-by-side, cyberscope, squashed side-by-side, and JPS stereoscopic JPEG. The system further comprises one or more infrared lasers for tracking the one or more of the viewer's head and eyes while displaying the three-dimensional information. However, the system does not require using one or more infrared lasers for tracking the one or more of a viewer's head and eyes while displaying the three-dimensional information. The three-dimensional information is viewed without a viewing aid. Alternatively, the three-dimensional information is viewed with a viewing aid. In another alternative the display displays two-dimensional information. In yet another alternative, the display is a projection display. The system further comprises a communication interface for communicating with one or more other devices to transmit and receive the three-dimensional information. Specifically, the communication interface communicates wirelessly. The system further comprises a control interface coupled to the electronic device for controlling the electronic device.

In yet another aspect, a system for acquiring and displaying three-dimensional information comprises an electronic device, a plurality of digital cameras coupled to the electronic device for autofocusing on and acquiring the three-dimensional information, a local memory for storing the three-dimensional information in a stereo format, an auto-stereoscopic display coupled to the electronic device for displaying the three-dimensional information, and the plurality of digital cameras for tracking one or more of a viewer's head and eyes and adjusting the three-dimensional information as it is displayed based on a position of the one or more of the viewer's head and eyes, a communication interface for communicating with one or more other devices to transmit and receive the three-dimensional information, and a control interface coupled to the electronic device for controlling the electronic device. The electronic device is from a group consisting of a PDA, camera phone, laptop computer, digital camera, video camera, and electronic watch. The three-dimensional information includes a set of images. The digital cameras include one or more charged coupled device sensors for acquiring the three-dimensional information. Autofocusing is determined by calculations whereby the calculations are from a group consisting of optical triangulation, range finding, and light pattern warping. The three-dimensional information is processed including compression, formatting, resolution enhancement, and color enhancement. The stereo format is one or more of above-below, line-alternate, side-by-side, cyberscope, squashed side-by-side, and JPS stereoscopic JPEG. The system further comprises one or more infrared lasers for tracking the one or more of the viewer's head and eyes while displaying the three-dimensional information. However, the system does not require using one or more infrared lasers for tracking the one or more of a viewer's head and eyes while displaying the three-dimensional information. Alternatively the display is a projection display. Specifically, the communication interface communicates wirelessly.

In another aspect, a method of acquiring and displaying three-dimensional information comprises autofocusing on the three-dimensional information using a plurality of digital cameras coupled to an electronic device, acquiring the three-dimensional information using the plurality of digital cameras, and displaying the three-dimensional information using a display. The electronic device is from a group consisting of a PDA, camera phone, laptop computer, digital camera, video camera, and electronic watch. The three-dimensional information includes a set of images. The digital cameras include one or more charged coupled device sensors for acquiring the three-dimensional information. Autofocusing is determined by calculations whereby the calculations are from a group consisting of optical triangulation, range finding, and light pattern warping. The method further comprises processing the three-dimensional information including compression, formatting, resolution enhancement, and color enhancement. The method further comprises storing the three-dimensional information in a local memory in a stereo format, wherein the stereo format is one or more of above-below, line-alternate, side-by-side, cyberscope, squashed side-by-side, and JPS stereoscopic JPEG. The method further comprises tracking one or more of a viewer's head and eyes using the plurality of digital cameras while displaying the three-dimensional information, specifically with one or more infrared lasers. However, the method does not require using one or more infrared lasers for tracking the one or more of a viewer's head and eyes while displaying the three-dimensional information. Alternatively the display is a projection display. The method further comprises communicating with one or more other devices using a communication interface to transmit and receive the three-dimensional information. Specifically the communication interface communicates wirelessly.

In yet another aspect, a method of acquiring and displaying three-dimensional objects comprises autofocusing on the three-dimensional objects using a plurality of digital cameras coupled to an electronic device, acquiring the three-dimensional objects using the plurality of digital cameras, tracking one or more of a viewer's head and eyes using the plurality of digital cameras, displaying the three-dimensional objects using a display, adjusting the three-dimensional objects as they is displayed based on a position of the one or more of the viewer's head and eyes, and communicating with one or more other devices using a communication interface to transmit and receive the three-dimensional objects. The electronic device is from a group consisting of a PDA, camera phone, laptop computer, digital camera, video camera, and electronic watch. The three-dimensional objects include a set of images. The digital cameras include one or more charged coupled device sensors for acquiring the three-dimensional objects. The method further comprises autofocusing determined by calculations whereby the calculations are from a group consisting of optical triangulation, range finding, and light pattern warping. The method further comprises processing the three-dimensional objects including compression, formatting, resolution enhancement, and color enhancement. The method further comprises storing the three-dimensional objects in a local memory in a stereo format, wherein the stereo format is one or more of above-below, line-alternate, side-by-side, cyberscope, squashed side-by-side, and JPS stereoscopic JPEG. The method further comprises tracking the one or more of the viewer's head and eyes using the plurality of digital cameras with one or more infrared lasers while displaying the three-dimensional objects. However, the method does not require using one or more infrared lasers for tracking the one or more of a viewer's head and eyes while displaying the three-dimensional objects. Alternatively, the display is a projection display. Specifically, the communication interface communicates wirelessly.

### BRIEF DESCRIPTION OF THE DRAWINGS

FIG. 1 illustrates an internal view of the components within an embodiment of the 3D acquisition and visualization system.

FIG. 2 illustrates a flowchart showing a method implemented by the 3D acquisition and visualization system.

FIG. 3 illustrates a graphical representation of an autofocusing system of the 3D acquisition and visualization system.

FIG. 4a illustrates a graphical representation of transmitting 3D information from an electronic device to a compatible device utilizing the 3D acquisition and visualization system.

FIG. 4b illustrates a graphical representation of transmitting 3D information from an electronic device to a compatible device via the Internet utilizing the 3D acquisition and visualization system.

### DETAILED DESCRIPTION OF THE PREFERRED EMBODIMENT

An embodiment of the 3D acquisition and visualization system is implemented in a personal electronic device including but not limited to a laptop computer, PDA, camera phone, digital camera, video camera, and electronic watch.

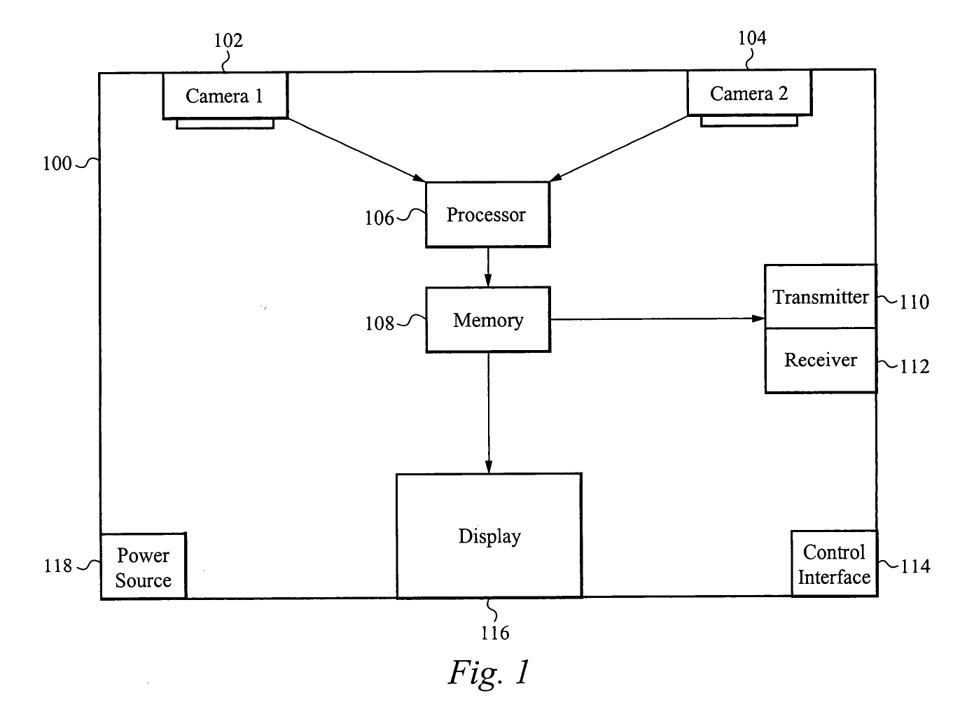

FIG. 1 illustrates an internal view of the components within the system of an embodiment of the 3D acquisition and visualization system. The electronic device 100 includes a number of components required to assure proper functionality of the system. In an embodiment, the electronic device is one or more of a number of different devices including a laptop computer, PDA, camera phone, digital camera, video camera or electronic watch. A first digital camera 102 and a second digital camera 104 are located substantially parallel to each other and are utilized in the processes of autofocusing, simultaneously acquiring 3D information, and eye-tracking for 3D display purposes. After the image is acquired by the first digital camera 102 and the second digital camera 104, a processor 106 is utilized via hardware or software to process the 3D information including compression, formatting, and eventually storage in a local memory 108. A transmitter 110 is available for transmitting the 3D information to one or more other electronic devices. A receiver 112 is included to receive 3D information from another electronic device. In addition to being transmitted to another device, the electronic device 100 includes a display 116 to display the stored 3D information. The display 116 includes eye-tracking which utilizes the first digital camera 102 and the second digital camera 104 to track the eyes of a viewer when displaying 3D information. The display 116 also comprises one or more of a variety of appropriate and available 3D display technologies to display the 3D information. A control interface 114 is utilized to allow a viewer to control a number of aspects of the electronic device 100 including settings and other features. A power source 118 provides power to the electronic device 100. Together, the components of the 3D acquisition and visualization system within the electronic device 100 allow a user to autofocus, acquire 3D information, track a viewer's eyes when displaying 3D information, transmit the 3D information to another device and display the 3D information.

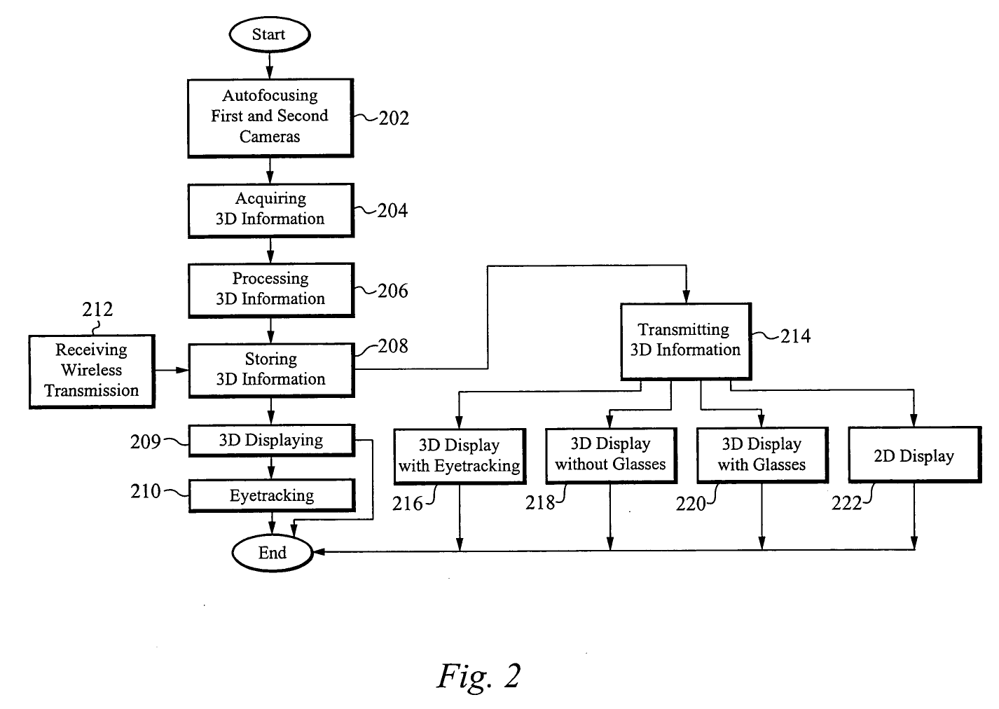

FIG. 2 illustrates a flowchart showing a method implemented by the 3D acquisition and visualization system. In step 202, the first digital camera 102 and the second digital camera 104 are utilized to autofocus on a desired object via optical triangulation. Then in step 204, the first digital camera 102 and the second digital camera 104 acquire the video or image including the object in 3D which is the 3D information. Once acquired, the processor 106 processes the 3D information in step 206 and compresses and formats the 3D information. Then, in step 208, the 3D information is stored in the local memory 108. After being stored, the 3D information is able to be displayed in step 209 to the viewer either with eye-tracking in step 210 or without eye-tracking. For eye-tracking, the first digital camera 104 and the second digital camera 106 determine where the viewer's eyes are and then ensure that the 3D information is shown to the viewer at the appropriate angle so that they will see the 3D information properly. The 3D information is also able to be transmitted to a compatible device in step 214. This transmission is by any appropriate means, including wired, wireless, infrared, radio-frequency, cellular and satellite transmission. Then a viewer of that compatible receiving device has the ability to view the 3D information depending on the configuration of the compatible device. Step 216 provides that if the compatible device permits 3D displaying with eyetracking, the viewer will see the 3D information similar to the display on the device including the 3D acquisition and visualization system, as described above. However, step 218 provides an alternative 3D displaying process where there is no eyetracking but glasses are not required, or conversely in step 220 where glasses are required. Also, if the compatible device only has a 2D display, the viewer will only see a 2D image as in step 222. The compatible device utilizes software to convert the 3D information to a 2D image. The electronic device 100 also has the ability to receive 3D information from other compatible devices as described in step 212. Similar to the electronic device's 100 ability to transmit 3D information, it has the ability to also receive 2D or 3D information for displaying purposes. Once the electronic device 100 receives the information via the receiver 112, the electronic device 100 will process the information as needed, then store it in the memory 108 and ultimately display the information to the viewer using eye-tracking for 3D viewing.

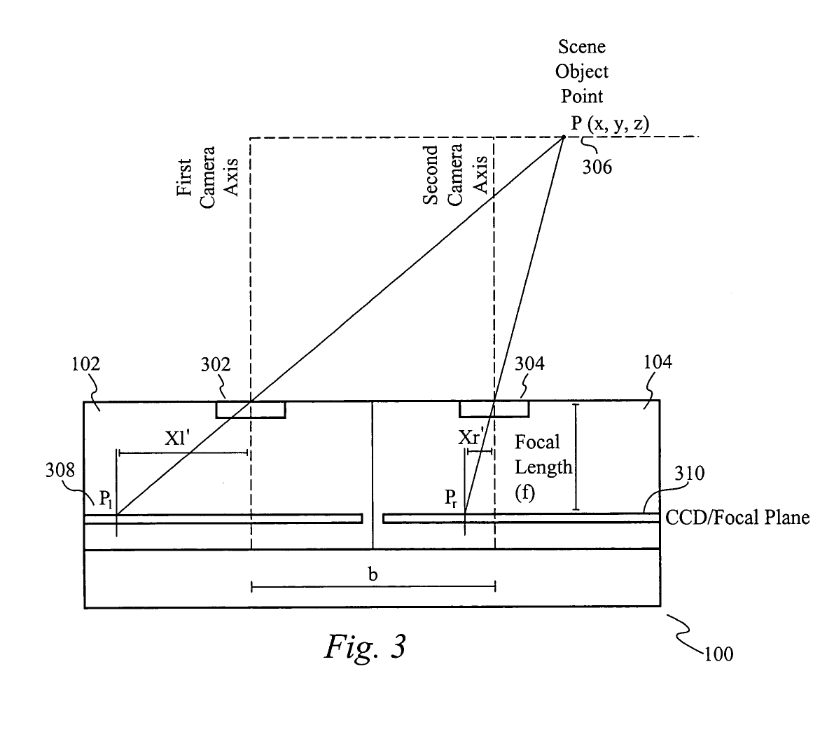

FIG. 3 illustrates a graphical representation of an autofocusing system of the 3D acquisition and visualization system. In an embodiment, the 3D acquisition and visualization system for personal electronic devices permits autofocusing utilizing the first digital camera 102 and a second digital camera 104. The system utilizes the first digital camera 102 and the second digital camera 104 to measure 3D geometry, color, and depth of an object. The first digital camera 102 has a first lens 302 and a first charged-coupled device (CCD) 308, and the second digital camera 104 has a second lens 304 and a second CCD 310. As is well known, CCD sensors allow a user to take a picture with a digital camera. Once a mechanical shutter of the digital camera is open, the CCD sensor is exposed to light through a lens. The CCD sensor converts the light into charge and then is converted to a signal. Then the signal is digitized and stored in memory. Finally, the acquired information is displayed, for example, on an LCD of the electronic device. In an embodiment, optical triangulation is used to focus the first digital camera 102 and the second digital camera 104 at the correct depth. Optical triangulation includes matching images of a point P 306 in the pictures obtained from the first digital camera 102 and the second digital camera 104. The first digital camera 102 and the second digital camera 104 are coupled to the electronic device 100 in parallel. A depth map is utilized to store the depth measurements which generally is a two dimensional array. The x and y components are encoded, and z is the depth measurement which corresponds to each point. For a pinhole camera, the depth (z) is calculated using the formula:
z=b*f/(xₗ′−xᵣ′)
where the focal length is f, the distance between the centers of the two digital cameras is b, the first image plane is xₗ′ and the second image plane is xᵣ′. The calculations are performed automatically by internal hardware and software of the electronic device 100; autofocusing the electronic device 100 very precisely.

Once the digital cameras are focused, acquiring the three-dimensional information is straightforward since the first digital camera 102 and the second digital camera 104 are coupled together in an electronic device 100. A user takes a picture as usual, and the first digital camera 102 and the second digital camera 104 each collect 3D information from slightly different angles, thus creating a stereoscopic image. Furthermore, since the digital cameras are placed very close together, most of the issues that have troubled stereoscopic cameras in the past are avoided.

An alternative embodiment of acquiring 3D information utilizes a laser range finder of appropriate size coupled to the electronic device 100 where the laser bounces off an object and a receiver calculates the time it takes for the reflected beam to return. The range finder helps in autofocusing at the correct distance, so that the first digital camera 102 and the second digital camera 104 acquire the correct data.

Another alternative embodiment of acquiring 3D information includes projecting patterns of light onto an object. The patterns could include grids, stripes, or elliptical patterns. Then the shape of the object is deduced from the warp of the light patterns. Depth is then calculated using the first digital camera 102 position and the second digital camera 104 position and the warping.

After the 3D information is acquired, it is processed and stored in the local memory 108 in the electronic device 100. Processing of the data includes compression, formatting, resolution enhancement and color enhancement. The 3D information is then stored in one or more of a variety of formats including above-below, line-alternate, side-by-side, cyberscope, squashed side-by-side, and JPS stereoscopic JPEG.

For a viewer to view the 3D information, an eye-tracking system is implemented so that the 3D information will stay in focus and in 3D at all times. The first digital camera 102 and the second digital camera 104 are utilized to implement the eye-tracking system. An embodiment for eye-tracking includes utilizing infrared LEDs surrounding the lenses of the first digital camera 102 and the second digital camera 104 so that the LED light sources are as close to the optical axes of the digital camera lenses as possible in order to maximize the retroreflectivity effect from the viewer's eyes. The difference in reflectivity between the eyes and the face will result in the eyes being white and the face being black and is sufficient to determine the location of the eyes. There are issues though when too much ambient light exists or the viewer is wearing glasses, but a differential analysis technique is used to remove unwanted reflections or extra-lighting problems. Alternatively, in a system without infrared LEDs, the digital cameras alternatively analyze and compare the images of the viewer and determine the location of the viewer's eyes. Once the location of the viewer's eyes are established, the first digital camera 102 and the second digital camera 104 continue to track them as the viewer is viewing the display 116. The images on the display 116 are rotated and/or moved as needed so that the viewer continuously views a 3D image.

An alternative embodiment of tracking a viewer includes tracking the viewer's head and then estimating where the viewer's eyes are located. The system obtains an outline of the viewer's head and then predicts where the viewer's eyes are located. There are a number of techniques that achieve head-tracking. Image analysis generally needs a known background or consistent and controlled ambient lighting. The infrared LEDs are located about the lenses of the first digital camera 102 and the second digital camera 104 and emit light towards the background and viewer. Here, there is no need for complex light level control, so CCD cameras are usable. The apertures of the cameras are adjusted so that exposed areas of the background appear completely white and the viewer will appear black. Then the outline of the viewer is established using software within the electronic device to approximate the eye locations. Alternatively, this process is performed without a retroreflective screen utilizing infrared stripes and the distortions of the stripes to calculate the location of the viewer's head. Alternatively, in a system without infrared LEDs, the digital cameras alternatively analyze and compare the images of the viewer and determine the location of the viewer's head and eyes.

An alternative embodiment of head-tracking includes acoustic range finding and using triangulation to find the position of the viewer's head. Ultrasonic transducers located on the electronic device 100 are utilized to transmit a pulse and receive the echoes from the pulse. By knowing the time delay between the sending of the pulse and when it is received, the distance of the object is triangulated. The procedure is repeated many times, and a continuous approximation of the viewer's head including location of the eyes takes place.

Another alternative embodiment includes a way of tracking multiple viewers' eyes whereby multiple projectors are used to display the 3D information to the viewers' eyes, and the 3D information is directed to the proper location.

There are many different options for devices to display the 3D information. An embodiment for the display 116 utilizes a parallax barrier technology which is used as a 3D autostereoscopic display or a 2D display. The parallax barrier comprises an array of slits spaced at a defined distance from a pixel plane. The intensity distribution across the window is modeled as a convolution of the detailed pixel structure and the near field diffraction through the aperture of the slit which results in an intensity variation at the window plane. Further, parallax barriers need to be aligned to the LCD with a high degree of precision. The parallax barrier can be made to be transparent to allow conversion between 2D and 3D.

An alternative embodiment utilizes lenticular elements to display the 3D information. Lenticular elements are typically cylindrical lenses arranged vertically with respect to a 2D display such as an LCD. The cylindrical lenses direct diffuse light from a pixel so it is only seen at a limited angle in front of the display. Thus, different pixels are directed to either left or right viewing angles. A 2D/3D switching diffuser is coupled to the front of the lenticular element to allow the viewer to switch between 2D and 3D. When the 2D/3D switching diffuser is off it scatters light and prevents the light from reaching the lenticular lens which results in similar performance to a normal 2D display.

Another alternative embodiment includes using an array of vertically oriented micro-prisms as the parallax element, and the left and right images, vertically interlaced in columns, are directed to two viewing windows by the micro-prisms.

Another alternative embodiment includes using a series of stacked micro-polarizer elements to generate a switchable parallax barrier. The micro-polarizer elements are constructed inside the LCD element to avoid common parallax problems.

Another alternative embodiment incorporates a viewing aid such as colored, polarized, or switching glasses to view the 3D information where the stereoscopic display is not autostereoscopic.

Another alternative embodiment includes utilizing a beamsplitter which uses light polarization to separate left-eye and right-eye stereoimages and direct the proper image to the appropriate eye.

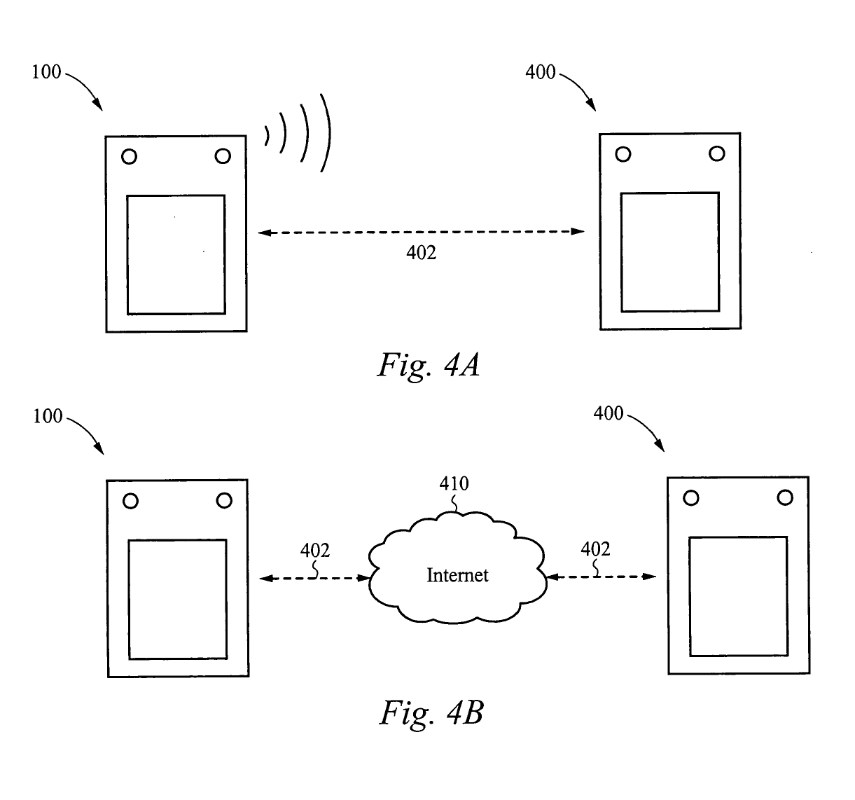

FIGS. 4a and 4b illustrate a graphical representation of transmitting 3D information from the electronic device 100 to a compatible receiving device 400 utilizing the 3D acquisition and visualization system. In addition to the ability of displaying the 3D information, the electronic device 100 has the capability of transmitting the 3D information wirelessly to the compatible device 400. Furthermore, the electronic device 100 has the capability to receive 3D information from the compatible device 400 as well. Types of wireless transmission include Bluetooth® 402 or a similar technology 402 for direct device-to-device transmission. Another type of wireless transfer includes coupling the electronic device to the Internet 410 whereby the 3D information is sent to a server, and then the compatible device 400 is able to wirelessly download the 3D information. As described above, the electronic device 100 includes a transmitter 110 and a receiver 112. The transmitter 110 and the receiver 112 are coupled such that they have the ability to transfer data to and from the processor 106, the memory 108, and the display 116 of the electronic device 100. The transmitter 110 may include an infrared transmission system or a radio-frequency transmission system. The compatible device 400 should include similar components although the compatible device 400 does not have to be an autostereoscopic device. The compatible device could be an autostereoscopic device, a stereoscopic device, or simply a 2D device. Obviously, depending on the device, to be able to view all of the features of the image may require additional hardware such as specialized glasses. As for the 2D device, the 3D image will only appear in 2D. In an alternative embodiment, the 3D information is transmitted non-wirelessly via a cable for example an ethernet cable, IEEE 1394 compatible cable, or USB cable.

An alternative embodiment of the present invention includes projecting the 3D information onto a screen for viewing. In addition to viewing the 3D information on the display 116, the electronic device 100 projects the 3D information onto a screen whereby viewing is achieved with the use of specialized glasses as described above.

In addition to all of the features described above for the stereoscopic acquiring and displaying capabilities, the electronic device 100 will retain all of the features inherent to it. For example, if the electronic device is a PDA with the stereoscopic features, a user has the ability to still store information, set schedules, and continue to use the PDA as before. Similarly, a camera phone will function as a phone in addition to the stereoscopic features. The 3D acquisition and visualization system enhances the electronic device 100 by adding stereoscopic features.

In operation the electronic device 100 is used substantially similar to a digital camera with the additional features of the underlying device which includes but is not limited to a laptop computer, PDA, camera phone, digital camera, video camera, and electronic watch. To take a 3D picture and acquire 3D information, the user powers on the electronic device 100. Then the user aims the electronic device's 100 first digital camera 102 and second digital camera 104 at a desired object. Finally, the user presses a button which is coupled to the first digital camera 102 and second digital camera 104 which take the picture. Before the picture is taken, while the user is aiming at the desired object, the autofocusing system of the first digital camera 102 and the second digital camera 104 automatically focus to the appropriate depth of the object so that the clearest possible picture is taken. The two cameras triangulate the depth of the object and focus quickly and clearly on the object. The first digital camera 102 acquires information from a first angle and the second digital camera 104 acquires information from a second angle slightly offset from the first angle. The processor 106 utilizes internal software and processes the separate information from each camera into one set of 3D information. After taking the picture, the user has options of viewing the 3D information on the display 116, transmitting the 3D information to the compatible receiving device 400, or projecting the 3D information to a screen. To view the 3D information on the electronic device 100, the first camera 102 and the second camera 104 are used to track the user's eyes, head or both. The user simply views the 3D information on the display 116 with the freedom to move around without losing focus on the 3D information. The display 116 further utilizes one or more of appropriate and available 3D display technology to display the 3D information. To transmit the 3D information to the compatible receiving device 400, the electronic device includes functionality needed to communicate with the compatible receiving device 400. Furthermore, the user interacts with the electronic device 100 to transmit the 3D information using an input device which includes but is not limited to a set of buttons to press, a touchscreen to touch, or nobs to turn. Additionally, the user may project the 3D information to an external screen whereby a visual aid is required to view the 3D information. A setup to project the 3D information includes stabilizing the electronic device 100 on a surface within a reasonably close proximity so that the 3D information is displayed clearly on the external screen. For example, the electronic device 100 is placed on a table, five feet from a pulldown white canvas display, and viewers wear polarized 3D glasses to view the projected 3D information.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

1. A system for acquiring and displaying three-dimensional information comprising:
a. an electronic device;
b. a plurality of digital cameras coupled to the electronic device for autofocusing on and acquiring the three-dimensional information; and
c. a display coupled to the electronic device for displaying the three-dimensional information.

2. The system as claimed in claim 1 wherein the electronic device is from a group consisting of a PDA, camera phone, laptop computer, digital camera, video camera, and electronic watch.

3. The system as claimed in claim 1 wherein the three-dimensional information includes a set of images.

4. The system as claimed in claim 1 wherein the digital cameras include one or more charged coupled device sensors for acquiring the three-dimensional information.

5. The system as claimed in claim 1 wherein autofocusing is determined by calculations whereby the calculations are from a group consisting of optical triangulation, range finding, and light pattern warping.

6. The system as claimed in claim 1 wherein the three-dimensional information is processed including compression, formatting, resolution enhancement, and color enhancement.

7. The system as claimed in claim 1 wherein the three-dimensional information is stored in a local memory in a stereo format.

8. The system as claimed in claim 7 wherein the stereo format is one or more of above-below, line-alternate, side-by-side, cyberscope, squashed side-by-side, and JPS stereoscopic JPEG.

9. The system as claimed in claim 1 wherein the plurality of digital cameras track one or more of a viewer's head and eyes while displaying the three-dimensional information.

10. The system as claimed in claim 9 wherein the plurality of digital cameras use one or more infrared lasers for tracking the one or more of a viewer's head and eyes while displaying the three-dimensional information.

11. The system as claimed in claim 1 wherein the display is a projection display.

12. The system as claimed in claim 1 wherein the display displays two-dimensional information.

13. The system as claimed in claim 1 wherein the three-dimensional information is viewed without a viewing aid.

14. The system as claimed in claim 1 wherein a viewing aid is needed to view the three-dimensional information.

15. The system as claimed in claim 1 further comprising a communication interface for communicating with one or more other devices to transmit and receive the three-dimensional information.

16. The system as claimed in claim 15 wherein the communication interface communicates wirelessly.

17. The system as claimed in claim 1 further comprising a control interface coupled to the electronic device for controlling the electronic device.

18. A system for acquiring and displaying three-dimensional information comprising:
a. an electronic device;
b. a plurality of digital cameras coupled to the electronic device for acquiring the three-dimensional information; and
c. a display coupled to the electronic device for displaying the three-dimensional information, wherein the plurality of digital cameras track one or more of a viewer's head and eyes and adjust the three-dimensional information as it is displayed based on a position of the one or more of the viewer's head and eyes.

19. The system as claimed in claim 18 wherein the electronic device is from a group consisting of a PDA, camera phone, laptop computer, digital camera, video camera, and electronic watch.

20. The system as claimed in claim 18 wherein the three-dimensional information includes a set of images.

21. The system as claimed in claim 18 wherein the digital cameras include one or more charged coupled device sensors for acquiring the three-dimensional information.

22. The system as claimed in claim 18 wherein the plurality of cameras are utilized for autofocusing.

23. The system as claimed in claim 22 wherein autofocusing is determined by calculations whereby the calculations are from a group consisting of optical triangulation, range finding, and light pattern warping.

24. The system as claimed in claim 18 wherein the three-dimensional information is processed including compression, formatting, resolution enhancement, and color enhancement.

25. The system as claimed in claim 18 wherein the three-dimensional information is stored in a local memory in a stereo format.

26. The system as claimed in claim 25 wherein the stereo format is one or more of above-below, line-alternate, side-by-side, cyberscope, squashed side-by-side, and JPS stereoscopic JPEG.

27. The system as claimed in claim 18 wherein the plurality of digital cameras use one or more infrared lasers for tracking the one or more of the viewer's head and eyes while displaying the three-dimensional information.

28. The system as claimed in claim 18 wherein the display is a projection display.

29. The system as claimed in claim 18 wherein the display displays two-dimensional information.

30. The system as claimed in claim 18 wherein the three-dimensional information is viewed without a viewing aid.

31. The system as claimed in claim 18 wherein a viewing aid is needed to view the three-dimensional information.

32. The system as claimed in claim 18 further comprising a communication interface for communicating with one or more other devices to transmit and receive the three-dimensional information.

33. The system as claimed in claim 32 wherein the communication interface communicates wirelessly.

34. The system as claimed in claim 18 further comprising a control interface coupled to the electronic device for controlling the electronic device.

35. A system for acquiring and displaying three-dimensional information comprising:
a. an electronic device;
b. a plurality of digital cameras coupled to the electronic device for autofocusing on and acquiring the three-dimensional information;
c. a local memory for storing the three-dimensional information in a stereo format;
d. an auto-stereoscopic display coupled to the electronic device for displaying the three-dimensional information, and the plurality of digital cameras for tracking one or more of a viewer's head and eyes and adjusting the three-dimensional information as it is displayed based on a position of the one or more of the viewer's head and eyes;
e. a communication interface for communicating with one or more other devices to transmit and receive the three-dimensional information; and
f. a control interface coupled to the electronic device for controlling the electronic device.

36. The system as claimed in claim 35 wherein the electronic device is from a group consisting of a PDA, camera phone, laptop computer, digital camera, video camera, and electronic watch.

37. The system as claimed in claim 35 wherein the three-dimensional information includes a set of images.

38. The system as claimed in claim 35 wherein the digital cameras include one or more charged coupled device sensors for acquiring the three-dimensional information.

39. The system as claimed in claim 35 wherein autofocusing is determined by calculations whereby the calculations are from a group consisting of optical triangulation, range finding, and light pattern warping.

40. The system as claimed in claim 35 wherein the three-dimensional information is processed including compression, formatting, resolution enhancement, and color enhancement.

41. The system as claimed in claim 35 wherein the stereo format is one or more of above-below, line-alternate, side-by-side, cyberscope, squashed side-by-side, and JPS stereoscopic JPEG.

42. The system as claimed in claim 35 wherein the plurality of digital cameras use one or more infrared lasers for tracking the one or more of the viewer's head and eyes while displaying the three-dimensional information.

43. The system as claimed in claim 35 wherein the display is a projection display.

44. The system as claimed in claim 35 wherein the communication interface communicates wirelessly.

45. A method of acquiring and displaying three-dimensional information comprising:
a. autofocusing on the three-dimensional information using a plurality of digital cameras coupled to an electronic device;
b. acquiring the three-dimensional information using the plurality of digital cameras; and
c. displaying the three-dimensional information using a display.

46. The method as claimed in claim 45 wherein the electronic device is from a group consisting of a PDA, camera phone, laptop computer, digital camera, video camera, and electronic watch.

47. The method as claimed in claim 45 wherein the three-dimensional information includes a set of images.

48. The method as claimed in claim 45 wherein the digital cameras include one or more charged coupled device sensors for acquiring the three-dimensional information.

49. The method as claimed in claim 45 wherein autofocusing is determined by calculations whereby the calculations are from a group consisting of optical triangulation, range finding, and light pattern warping.

50. The method as claimed in claim 45 further comprising processing the three-dimensional information including compression, formatting, resolution enhancement, and color enhancement.

51. The method as claimed in claim 45 further comprising storing the three-dimensional information in a local memory in a stereo format.

52. The method as claimed in claim 51 wherein the stereo format is one or more of above-below, line-alternate, side-by-side, cyberscope, squashed side-by-side, and JPS stereoscopic JPEG.

53. The method as claimed in claim 45 further comprising tracking one or more of a viewer's head and eyes using the plurality of digital cameras while displaying the three-dimensional information.

54. The method as claimed in claim 53 further comprising tracking the one or more of the viewer's head and eyes using the plurality of digital cameras with one or more infrared lasers while displaying the three-dimensional information.

55. The method as claimed in claim 45 wherein the display is a projection display.

56. The method as claimed in claim 45 further comprising communicating with one or more other devices using a communication interface to transmit and receive the three-dimensional information.

57. The method as claimed in claim 56 wherein the communication interface communicates wirelessly.

58. A method of acquiring and displaying three-dimensional objects comprising:
a. autofocusing on the three-dimensional objects using a plurality of digital cameras coupled to an electronic device;
b. acquiring the three-dimensional objects using the plurality of digital cameras;
c. tracking one or more of a viewer's head and eyes using the plurality of digital cameras;
d. displaying the three-dimensional objects using a display;
e. adjusting the three-dimensional objects as they are displayed based on a position of the one or more of the viewer's head and eyes; and
f. communicating with one or more other devices using a communication interface to transmit and receive the three-dimensional objects.

59. The method as claimed in claim 58 wherein the electronic device is from a group consisting of a PDA, camera phone, laptop computer, digital camera, video camera, and electronic watch.

60. The method as claimed in claim 58 wherein the three-dimensional objects include a set of images.

61. The method as claimed in claim 58 wherein the digital cameras include one or more charged coupled device sensors for acquiring the three-dimensional objects.

62. The method as claimed in claim 58 wherein autofocusing is determined by calculations whereby the calculations are from a group consisting of optical triangulation, range finding, and light pattern warping.

63. The method as claimed in claim 58 further comprising processing the three-dimensional objects including compression, formatting, resolution enhancement, and color enhancement.

64. The method as claimed in claim 58 further comprising storing the three-dimensional objects in a local memory in a stereo format.

65. The method as claimed in claim 64 wherein the stereo format is one or more of above-below, line-alternate, side-by-side, cyberscope, squashed side-by-side, and JPS stereoscopic JPEG.

66. The method as claimed in claim 58 further comprising tracking the one or more of the viewer's head and eyes using the plurality of digital cameras with one or more infrared lasers while displaying the three-dimensional objects.

67. The method as claimed in claim 58 wherein the display is a projection display.

68. The method as claimed in claim 58 wherein the communication interface communicates wirelessly.
